(19) United States
(12) Patent Application Publication
(10) Pub. No.: US 2025/0154068 A1
(43) Pub. Date: May 15, 2025

(54) METHOD OF MAKING A DIAMOND COMPOSITE

(71) Applicant: SANDVIK MACHINING SOLUTIONS AB, Sandviken (SE)

(72) Inventors: John DE FLON, Sandviken (SE); Malin MARTENSSON, Sandviken (SE); Carl DOSSLING, Sandviken (SE)

(21) Appl. No.: 18/721,988

(22) PCT Filed: Dec. 16, 2022
(86) PCT No.: PCT/EP2022/086319

§ 371 Date: Jun. 20, 2024

(30) Foreign Application Priority Data
Dec. 21, 2021 (EP) 21216413.1

(51) Int. Cl. C04B 35/52; C04B 35/638; C04B 41/51

(52) U.S. Cl. CPC C04B 35/52; C04B 35/638; C04B 41/5183; C04B 2235/427; C04B 2235/428; C04B 2235/602; C04B 2235/616; C04B 2235/6562; C04B 2235/6567; C04B 2235/6581

(57) ABSTRACT

In a method of making a diamond composite a diamond green body, together with an infiltrant, is placed onto a graphite crucible and the graphite crucible is placed onto a carbon source, such that during infiltration, excess infiltrant is leaked down to the carbon source and excess infiltrant is thus avoided on the diamond composites.

The present invention relates to a method of making a diamond composite for which the residual infiltrant is removed already during the infiltration step.

### BACKGROUND

Diamond composites are known in the art and can be used for many applications like cutting tools, mining bits etc.

The diamond composites can be manufactured in different ways, e.g. by forming a green body comprising diamond particles and then during an elevated temperature letting an infiltrant, usually silicon, react with some of the diamond particles to form a carbide binder, usually SiC, in which the diamond particles are embedded in. This step can either be made at both high temperature and high pressure but diamond composites can also be done by infiltration at a lower pressure or even in vacuum depending on what type of composite is required.

For the diamond composites that are infiltrated at a more moderate pressure, residual infiltrant left on the diamond composite is a problem. If the final composite body has holes or cavities, these are often filled with residual infiltrant which then has to be removed. If thin and/or hollow details are printed residual solidified silicon can also cause cracks and breakages due to the tensile forces created in the sintered body during solidification when the silicon expands. Residual infiltrant can also react with the graphite sintering trays in the sintering furnace and they will then have to be replaced more often.

The excess infiltrant can be removed mechanically e.g. by blasting which is efficient if the diamond composite does not comprise any internal holes or channels. If the diamond composite comprises internal holes or channels, blasting will not suffice and the residual infiltrant has to be removed by dissolving it in e.g. a strong acid like HF. Both these processes are complicated and time consuming and especially the use of strong acids is hazardous.

Residual infiltrant can also lead to that the infiltrated pieces adhere to the underlying material during infiltration and that would require an extra step to release the pieces.

Residual infiltrant is a problem for all shapes of diamond composites but is particularly problematic for shapes that include holes and cavities.

Additive manufacturing or 3D printing is known to be suitable for making complex geometries, especially with cavities, internal holes and channels which would otherwise be difficult and/or very expensive to achieve.

One object of the present invention is to achieve a method of making a diamond composite that can reduce the residual infiltrant to a minimum to avoid the above mentioned problems.

### DETAILED DESCRIPTION OF THE PRESENT INVENTION

The present invention relates to a method of preparing a diamond composite comprising the following steps:
providing at least one diamond green body comprising at least 25 vol % diamond particles and an organic binder;
providing an infiltrant;
placing the at least one diamond green body together with an infiltrant onto a graphite crucible;
subjecting the at least one diamond green body to at least one debinding step before and/or after placing the at least one diamond green body together with an infiltrant onto a graphite crucible, thus forming at least one debound diamond green body
subjecting the at least one debound diamond green body to an infiltration step at a temperature of between 150° and 1680° C. in vacuum or in the presence of a protective gas at a pressure of below 50 mBar, for a time between 5 and 60 minutes;
   wherein, during the infiltration step the graphite crucible, together with the at least one debound diamond green body and the infiltrant, is placed onto an underlying carbon source.

By diamond green body is herein meant a body which comprises diamond particles and an organic binder. The amount of diamond particles is at least 25 vol %, preferably between 30 and 75 vol %, more preferably between 35 and 70 vol % of the green body.

By debound diamond green body is herein meant a diamond green body wherein at least 60% of the organic binder has been removed.

The debound diamond green bodies are placed onto a graphite crucible together with the infiltrant. The diamond green bodies can either be placed directly onto the graphite crucible, next to the infiltrant, or on top of the infiltrant. The distance between the debound diamond green body and the infiltrant should preferably be small enough for them to be in direct contact with each other once the infiltrant is in its molten state during infiltration.

The graphite crucible (can also be called ship) can be any type of foil, sheet, ship or crucible that is suitable for infiltration in a furnace. The graphite crucible should be thin and/or porous enough to allow the residual infiltrant to pass through to the underlying carbon source. After infiltration, the graphite crucible has reacted with the infiltrant and is mostly composed of the carbide of the infiltrant, i.e. if the infiltrant is Si, the crucible will be transformed into SiC during infiltration.

Preferably, a graphite foil or sheet is used. A foil or sheet is suitable for several reasons. An adequate thickness is easily obtained and also, since the graphite crucible is only used once, a foil or sheet is cost efficient. The thickness of the graphite foil or sheet is preferably between 0.05 and 3 mm, more preferably between 0.1 and 2 mm and most preferably 0.1 to 0.5 mm.

In one embodiment of the present invention, the graphite crucible is formed so that it encloses the diamond green body. For example, if a graphite foil is used, the foil is usually soft and can be wrapped around the diamond green body. This can be beneficial to avoid contamination on the surface of the diamond green body from the carbon source.

Optionally, the infiltrant may be selected from silicon, silicon compositions, aluminium and aluminium alloys. Preferably the infiltrant is Si. The infiltrant can be provided as lumps, coarse powders, wafers etc., preferably lumps or wafers. The amount of infiltrant is preferably present in large excess in relation to the diamond green bodies, preferably more than 200 wt % excess of the amount infiltrant needed to theoretically fully infiltrate the diamond body. If the amount of infiltrant is too small the diamond composites will not be fully infiltrated and graphitization of the diamonds occurs.

In one embodiment of the present invention the infiltrant is silicon. Suitably the infiltrant may comprise silicon having a purity greater than 99 wt % and may be present in large excess (greater than 200 wt % excess).

The infiltrant is placed together with the debound diamond green bodies onto the graphite crucible. The infiltrant should preferably be placed close to the debound diamond green bodies so that when the infiltrant melts it will be in contact with the diamond green bodies.

The graphite crucible, together with the debound diamond green bodies and the infiltrant on top of the graphite crucible, is then placed on top of a carbon source so that the graphite crucible, is in contact with the carbon source. The carbon source can be any material mainly containing carbon, preferably at least 95 wt % carbon. The carbon source should preferably be added in excess of the infiltrant used. By that is meant that enough carbon source has to be present to react with the total amount of infiltrant. The amount of carbon source used is also dependent on the size and number of diamond green bodies to be infiltrated. If the amount of carbon source is too small, the excess infiltrant will still be present on the infiltrated diamond composites and the infiltrated diamond composites might be adhered to the graphite crucible.

The carbon source is preferably a powder containing carbon. It can be provided as an agglomerated powder or as carbon particles. Preferably, the carbon source is a carbon or graphite powder, more preferably carbon powder in the form of soot or carbon black. Preferably, the powder is not too compact in order for the infiltrant to easily react with the powder. The powder is usually placed onto a tray inside the furnace and the powder bed should preferably have a height of at least 5 mm, preferably of at least 10 mm, but less than the height of the tray, to avoid the infiltrant to leak through to the underlying tray onto which the carbon source is placed.

Prior to infiltration, the green diamond bodies are subjected to at least one debinding step to form a debound green body. Since the diamond green bodies comprise large amounts of organic binder, at least a considerable amount of the organic binder has to be removed from the body in a controlled manner prior to infiltration in order to avoid cracks. By considerable amount is herein meant that at least 60%, preferably at least 70% of the organic binder is removed. Some remaining organic binder can in some cases be left in the debound diamond green body. If the debinding step is performed as a separate step and the diamond green bodies have to be moved, some remaining organic binder can be beneficial for the strength of the diamond green body which might otherwise easily break during handling. The remaining organic binder can in those cases either be removed in a second debinding step included in the beginning of the infiltration step or remain in the diamond green body. If the debound diamond green body contains any residual organic binder during infiltration, the carbon in the organic binder will then react with the infiltrant during infiltration and thus limit the amount of diamond that is lost due to reaction with the infiltrant.

The diamond green bodies are subjected to at least one debinding step before and/or after placing the at least one diamond green body diamond green body together with an infiltrant onto a graphite crucible. The debinding step can thus either be performed as a separate step or incorporated as a first step in the infiltration step.

For larger pieces it can be advantageous to perform the debinding step in a separate furnace allowing the binder to be removed slowly and thus avoid cracks.

Preferably, the debinding step is incorporated into the infiltration step and is performed in the same furnace.

The de-binding step may comprise heating the diamond green body up to a first maximum temperature by incremental temperature increase. Optionally, the incremental temperature increase comprises increments of 0.1 to 5° C./min, preferably 0.1 to 2° C./min. Optionally, the de-binding is performed in an environment selected from nitrogen, argon, hydrogen and mixtures thereof. Air may also be used as an environment. Optionally, the maximum de-binding temperature is in a range 180° C. to 550° C., preferably 200° C. to 500° C. The de-binding temperature will depend on the environment in which the de-binding step is performed (gas used) but also on the type of organic binder that is used. The time for the de-binding step can vary widely depending on the size of the diamond green body, type of binder, amount of binder and atmosphere. If the debinding step is too fast, cracks occur in the diamond green body. The debinding step is typically between 1 to 50 hours, preferably between 1 to 24 hours.

The infiltration suitably takes place at a temperature of between 150° and 1680° C., preferably between 155° and 1660° C. The infiltration is performed in vacuum or in the presence of a protective gas at a pressure of below 50 mBar, for preferably between 5 and 60 minutes, preferably between 10 and 45 minutes. By vacuum is herein meant that the pressure in the furnace is below 5×10−1 mbar, preferably below 5×10−2 mbar. An inert gas can be used in order to protect the furnace, preferably the gas is argon, and the argon pressure is below then preferably below 50 mbar.

In one embodiment of the present invention, the temperature is increased, from the de-binding temperature, with between 3° and 60° C./min, preferably with between 3° and 55° C./min until the desired infiltration temperature is reached. If the increase in temperature is too slow, graphitization of the diamond particles can occur before the infiltrant melts. A fast increase in temperature also makes the infiltrant melt fast and thus achieves the low viscosity that is beneficial for an efficient infiltration.

The cooling is then done in a controlled way, at a rate of between 2 and 30° C./min until the temperature is at least below 1300° C.

In one embodiment of the present invention, at the end of the infiltration step, a pressure of below 200 Bar is applied using an inert gas e.g. Ar or N₂, preferably Ar, for a time of at least 3 minutes before the temperature starts to decrease, for example between 3 to 45 minutes. This is done in order to further densify the composite body and allow the infiltrant to fully react to form the carbide.

During the infiltration step, some of the diamond particles are consumed due to the reaction with the infiltrant but the diamond composite suitably contains at least 50% of the diamond particles present in the diamond green body.

The diamond green body can be formed using any method known in the art. By diamond green body is herein meant an unsintered body comprising diamond grains and an organic binder. Examples of suitable methods of making the diamond green body is 3D printing technique or compaction.

Any additive manufacturing method or 3D printing technique known in the art can be used such as binder jetting, stereolithography etc. Preferably stereolithography is used. The exact printing parameters to be applied depends on the specific equipment used.

To form a printed body, typically, first a feedstock is formed comprising diamond particles and an organic binder. The composition of the feedstock and the properties like viscosity etc. depends on what type of composite that is to be printed, the type of organic binder and the printing equipment used.

After printing, the printed green body is removed from the printing equipment and is preferably cleaned to remove any excess powder and binder.

Depending on the type of printing technique used, the printed body might be subjected to a curing step after the printing step.

For e.g. diamond green bodies produced by stereolithography, the curing takes place during the printing and a green body is formed directly.

The diamond green body can also be made by more conventional methods like compaction. A slurry is then prepared comprising the diamond grains, an organic binder, typically PEG (polyethylene glycol). The slurry is then dried, preferably using spray drying or freeze drying to form granules which is then pressed into a green body using e.g. uni-axial pressing. The diamond green body obtained by compaction preferably has an organic binder content of between 10 and 30 vol %, preferably 15 and 25 vol %.

The diamond particles used to prepare the diamond green body optionally have an average particle size of less than 200 μm, preferably less than 150 μm, more preferably less than 100 μm. Optionally, the diamond particles may comprise an average particle size in the range of 0.5 μm to 100 μm preferably 1 μm to 100 μm and more preferably 2 μm to 80 μm. In particular, the diamond particles may comprise a bi-modular or multi-modular particle size distribution. Optionally, at least one fraction of diamond particles comprising an average particle size of less than 30, 20 or 10 μm and at least one fraction of diamond particles comprising a particle size of less than 100, 80, 70, 60 or 50 μm. Such an arrangement is advantageous to optimize the packing of the diamond within the resulting green bodies and the final infiltrated articles.

By organic binder is herein meant any binder common in the art of making diamond green bodies. Depending on how the diamond green body is manufactured the composition of the organic binder will vary.

The organic binders used for diamond green bodies made by conventional compaction technique is usually PEG (polyethylene glycol). Preferably the organic binder is added in an amount of between 10 and 30 vol %, preferably between 15 and 25 vol % of the green diamond body.

The binders used for 3D printing have a wider variety in composition. The type of binder is dependent on the type of printing technique used. The amount of organic binder is usually between 5 and 60 vol %, preferably between 5 and 58 vol % of the green diamond body. The organic binder preferably has one or more organic compounds selected from the group consisting of resins, polysaccharides, polyvinyl alcohol, cellulose and cellulose derivatives, lignin sulfonates, polyethylene glycol, polyvinyl derivatives, polyacrylates and mixtures thereof.

In one embodiment of the present invention where stereolithography (SLA) is used, the binder content is preferably between 40 and 60 vol %, preferably between 50 and 58 vol %. The organic binders used for stereolithography are usually photopolymers. By that is meant that the polymer will react and cure when exposed to light, e.g. a UV lamp. The organic binders for stereolithography can also be called photo-curable resins.

Other additives common in diamond composites can also be added to the feed stock such as TiC, B₄C, ZrC. The amounts of additives are usually quite small, preferably below 10 wt %, more preferably between 0.1 and 5 wt % of the total diamond green body.

### DRAWINGS

FIG. 1 shows a schematic image of the set up prior to infiltration where A is the diamond green body, B is the infiltrant, C is the graphite crucible, D is the carbon source and E is the compact graphite sintering tray.

FIG. 2 shows a diamond green body in the shape of a test cube printed with stereolithography according to Example 1.

FIG. 3 shows a diamond composite body in the shape of a test cube after infiltration according to the present invention from Example 1.

FIG. 4 shows a diamond green body from Example 2 in a graphite crucible together with Si lumps prior to infiltration.

FIG. 5 shows a diamond composite body from Example 2 in the graphite crucible after infiltration.

FIG. 6 shows a CT scan of the diamond composite body from Example 2.

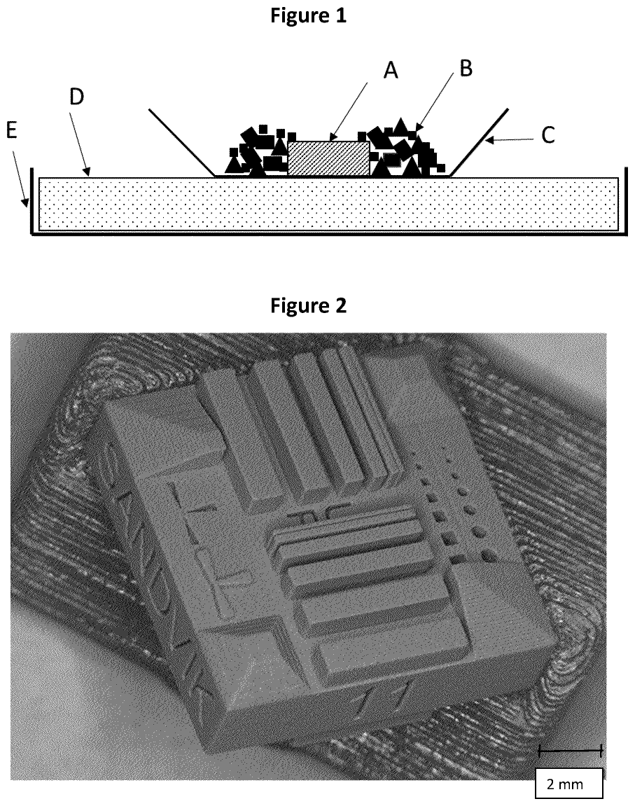

### EXAMPLE 1

Diamond green bodies were prepared using the 3D printing technique called stereolithography (SLA).

A feed for the printing step was prepared from diamond powders and an organic binder. Diamond powder from Hyperion, MBM-ULC, was used which contained 80 wt % of diamonds grains having a grain size of 20-30 μm, and 20 wt % of diamonds grains having a grain size of 4-8 μm.

53 vol % of the diamond powder was mixed with 47 vol % of an organic binder being a photo reactive resin provided by Incus GmbH.

The 3D printing processes were performed in a 3D printer from Incus named Hammer HD35 using the following settings: 40 μm layer height, 100 mW exposure intensity, 4.5 seconds exposure time, 82° C. blade temperature, 18° C. chamber temperature.

The printed pieces were test cubes comprising different patterns on the surface as well as holes, see FIG. 2.

After printing, the pieces were removed and cleaned using IncuSol followed by pre-conditioning at 120° C. for 72 hours in vacuum.

The diamond containing green bodies were then placed together with a Si infiltrant onto a graphite foil having a thickness of 0.2 mm (Mersen Papyex N98). The Si infiltrant was provided in large excess, >200 wt % of the green bodies, and was crushed Si pieces approximately 4-8 mm from ReSiTech.

When the samples were placed in the furnace, some of the graphite foils were then placed on top of a bed of carbon powder, ultrafine carbon black from IMCD Nordic AB, with a height of approximately 10 to 20 mm and for comparison, some graphite foils were placed directly onto the compact graphite sintering tray.

Debinding and infiltration were then performed in the same furnace, a GPS Furnace. The debinding was performed by, during about 7 hours, stepwise heating the diamond green bodies up to 500° C. in H₂. After that, the temperature was increased up to 575° C. where the temperature was kept for 1 hour. Then vacuum was applied, and the temperature was increased further. From 700° C. to 1350° C. the temperature was increased by 43° C./min. At 1350° C. the temperature was kept for 2 minutes, after which the temperature was further increased by 37° C./min up to 1630° C. At 1630° C. the temperature was kept for 5 minutes after which Ar was introduced into the furnace during 10 minutes until the pressure was 100 Bar. After that, the temperature 1630° C. was kept for an additional 10 minutes. The temperature was then decreased in a controlled manner, 7.8° C./min, to 1000° C. After that it was free cooling.

When the samples were investigated after the infiltration, the samples according to the invention (i.e. where a bed of carbon black powder has been used) were easily removed and did not contain any excess Si after a visual inspection. The small holes in the printed bodies according to the present invention were not filled with Si, samples for which no carbon powder had been used under the graphite foil was stuck to the graphite foil and had to be removed by force. The small holes were filled with Si.

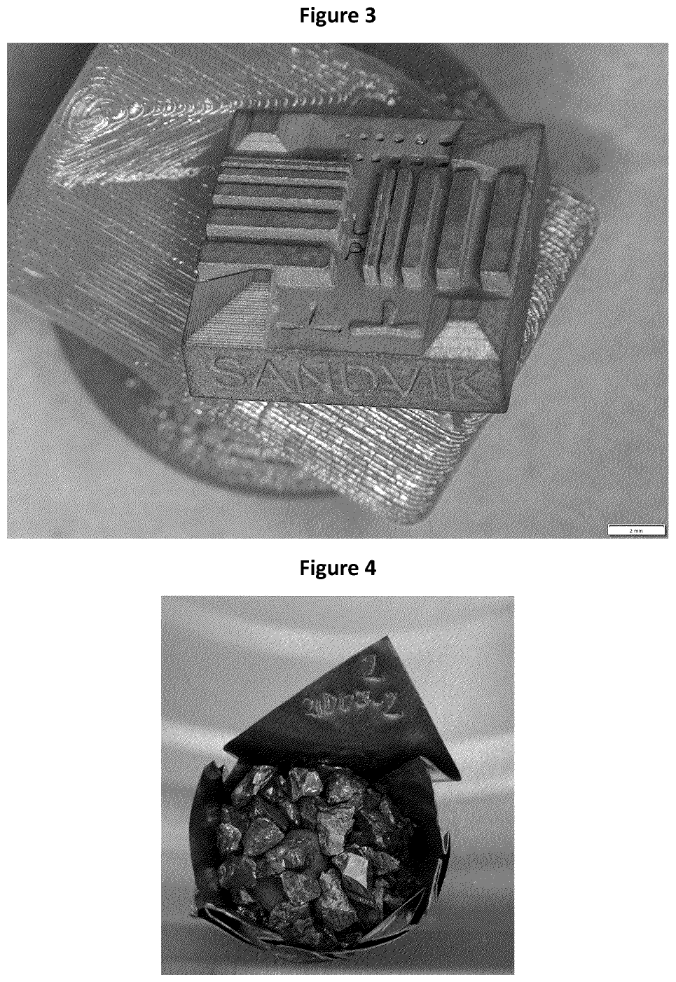

FIG. 3 shows one of the test cubes after infiltration according to the present invention.

All pieces, both according to the invention (with bed of carbon powder) and comparative (without the bed of carbon powder) were infiltrated to full density.

### EXAMPLE 2

Pressed diamond green bodies were manufactured using the following raw materials.

### Sample A

Diamond powders were dry blended together with a well de-agglomerated TiC powder to form a uniform mixture. The powder mixture was a multi-modal mixture of MBM-diamonds from Diamond Innovation with particle sizes in the range of 6 to 80 μm, which gives a high density during compaction. In addition to the diamond blend, also 2 wt % of TiC was added to the slurry.

A homogenous slurry was prepared using this mixture and then adding PEG1500 and PEG4000 as temporary organic binders and Acusol 460 NK as a dispersant agent, with de-ionized water as the fluid. The slurry was freeze spray granulated and dried to produce granules for pressing and the amount of organic binders in the powder was 7.92 wt % corresponding to 20 vol %. Granules were used in uni-axial pressing of green bodies in the shape of tool tips typically used in mining operations to a green density as high as possible with the used compaction technique. The pressing pressures were about 20 kN and the relative diamond density in the green bodies was around 66%. The green bodies were slowly heated up to 220° C. in the presence of air to partially remove the PEG to create a partly de-bound diamond green body of enough strength for further handling.

### Samples B and C

Diamond powders were dry blended together to form a uniform mixture. The diamond was a mixture of 80 wt % 20 to 30 micron and 20 wt % 4 to 8 micron diamond of grade MBM from Diamond Innovations Inc,. Homogenous slurry was prepared using this mixture and then adding PEG1500 and PEG4000 as temporary organic binders, with de-ionized water as the fluid. The slurry was spray granulated to produce granules for pressing and the amount of organic binders in the powder was 9.26 wt % which corresponds to 23 vol %. Granules were used in uni-axial pressing of green bodies in the shape of a cylinder (RNGN), 2 mm diameter for Sample B and 5 mm diameter for sample C, typically used in metal cutting operations to a green density as high as possible with the used compaction technique. The force applied for the compaction of the green bodies was typically 40-50 kN. The relative diamond density in the green bodies was around 60%. The relative diamond density in percentage was calculated as the mass of diamonds in the green body (temporary organic binders and other additions excluded) divided by the volume of the green body obtained from the press tool drawing divided by the X-ray density of diamonds (3.52 g/cm³), multiplied by 100. Depending on the compaction technique and the shape of the body the density can vary slightly between different parts of the green body. The green bodies were slowly heated up to 220° C. in the presence of air to partially remove the PEG to create partially de-bound diamond green body of enough strength for further handling.

The diamond green bodies, Samples A-C, were then subjected to the same infiltration step as described in Example 1 where the graphite foils were placed on top of a bed of carbon powder, ultrafine carbon black from IMCD Nordic AB, with a height of approximately 10 to 20 mm and for comparison one graphite foil containing diamond green bodies (Sample A), were placed directly onto the compact graphite sintering tray.

All diamond composites that were infiltrated according to the invention (i.e. where a bed of carbon black powder has been used) were easily removed and did not contain any excess Si after a visual inspection.

The different weights of the diamond green bodies/diamond composites at different stages are shown in Table 1.

TABLE 1

| | | Weight | Weight | Relative | | |
|---|---|---|---|---|---|---|
| | Diamond | Green | debound | density | Sintered | Density |
| | Green | body | Green | after | weight | sintered |
| | body | (g) | body (g) | pressing (%) | (g) | body (g/cm³) |
| Invention 1 | A | 8.96 | 8.31 | 66 | 11.99 | 3.357 |
| Invention 2 | B | 1.15 | 1.07 | 60 | 1.290 | 3.350 |
| Invention 3 | C | 3.14 | 2.91 | 60 | 4.516 | 3.326 |
| Comparison 1 | A | 9.10 | 8.47 | 66 | 11.99 | 3.360 |

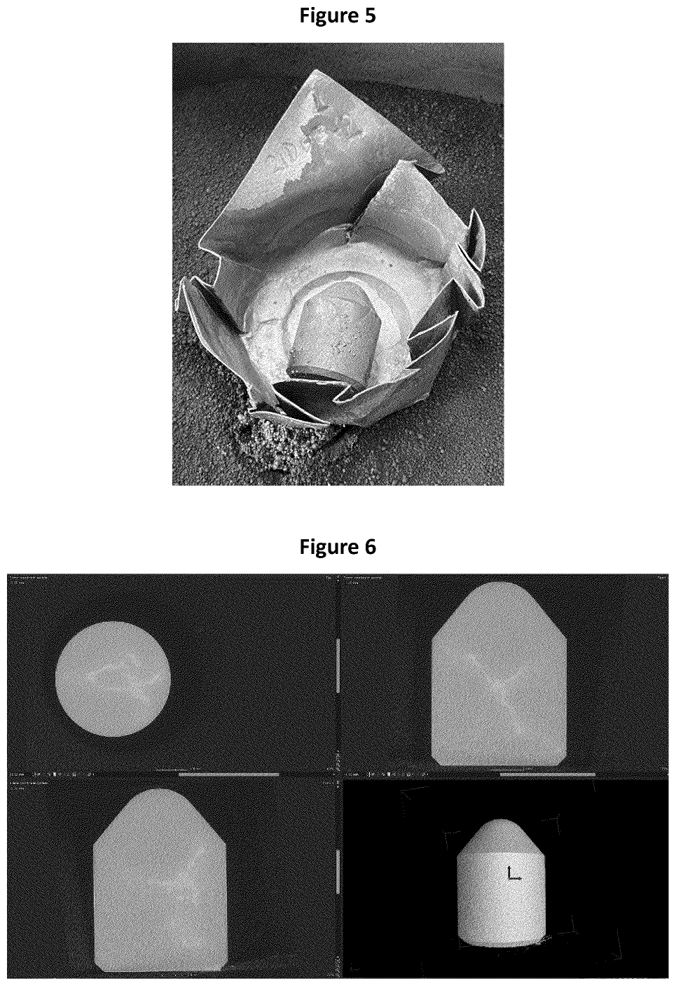

In FIG. 4 the graphite foil with the Si infiltrant and the pressed bit (Sample A) is shown before infiltration and the infiltrated diamond composite after infiltration is shown in FIG. 5. In FIG. 6, an image of Invention 1 using X-ray computer tomography (CT) is shown.

The samples (Comparison 1) for which no carbon powder had been used under the graphite foil was stuck to the graphite foil and to each other and had to be removed by force.

All pieces, both according to the invention (with bed of carbon black powder) and comparative (without the bed of carbon powder) were infiltrated to full density as can be seen in Table 1.

1. A method of preparing a diamond composite comprising the steps of:
providing at least one diamond green body including at least 25 vol % of diamond particles and an organic binder;
providing an infiltrant;
placing the at least one diamond green body together with the infiltrant onto a graphite crucible;
subjecting the at least one diamond green body to at least one debinding step before and/or after placing the at least one diamond green body together with the infiltrant onto the graphite crucible, thus forming at least one debound diamond green body; and
subjecting the at least one debound diamond green body to an infiltration step at a temperature of between 1500 and 1680° C., in a vacuum or in a presence of a protective gas at a pressure of below 50 mBar, for a time between 5 and 60 minutes, wherein, during the infiltration step, the graphite crucible, together with the at least one debound diamond green body and the infiltrant, is placed onto an underlying carbon source.

2. The method according to claim 1, wherein the at least one diamond green body during the at least one debinding step is subjected to a temperature of between 180 and 550° C., for a time between 1 and 15 hours.

3. The method according to claim 1, wherein the graphite crucible is a graphite foil or sheet.

4. The method according to claim 3, wherein the graphite foil has a thickness of between 0.05 and 3 mm.

5. The method according to claim 1, wherein the infiltrant is Si.

6. The method according to claim 1, wherein the infiltrant is added in excess of 200 wt % of the at least one diamond green body.

7. The method according to claim 1, wherein carbon source is a carbon powder.

8. The method according to claim 7, wherein the carbon powder is provided as a powder bed with a height of at least 5 mm.

9. The method according to claim 1, wherein at an end of the infiltration step, a pressure of below 200 Bar is applied using an inert gas for at least 3 minutes before the temperature starts to decrease.

10. The method according to claim 1, wherein the diamond green body is prepared by 3D printing.

11. The method according to any claim 10, wherein the diamond green body is prepared by stereolithography.

12. The method according to any of claims claim 1, wherein the diamond green body is prepared by compaction.
